(19) United States
(12) Patent Application Publication
(10) Pub. No.: US 2010/0250413 A1
(43) Pub. Date: Sep. 30, 2010

(54) Method and system for processing and collecting real estate loan payoffs from physically remote locations using ACH and RDC

(76) Inventor: John Vaillant Fox, Loganville, GA (US)

Correspondence Address: John V. Fox, P.O. Box 81, Loganville, GA, 30052, US

(21) Appl. No.: 12/382,770

(22) Filed: Mar. 24, 2009

(51) Int. Cl. G06Q 20/00; G06Q 40/00; G06Q 10/00

(52) U.S. Cl. 705/34; 705/44; 705/40

(57) ABSTRACT

A system that utilizes computer hardware, computer software, apparatus, and methodology that provides electronic interaction and process automation that enables businesses, individuals and all types of organizations to payoff a real estate loan from a remote location by securely entering and transmitting financial payment information either using ACH or RDC (check images), and other information that may be required. Credit for payment is passed to the mortgagee account on the lien holders system, check images (and or physical checks “IRD”) and ACH payments are entered into the bank check clearing channels for ultimate delivery to the maker bank for payment collection.

### CROSS REFERENCE TO RELATED APPLICATIONS

Not Applicable

### STATEMENT OF FEDERALLY SPONSORED RESEARCH/DEVELOPMENT

Not Applicable

### REFERENCE TO A “SEQUENCE LISTING”

Not Applicable

### BACKGROUND OF THE INVENTION

1. Field of Invention

The present process improvement invention relates to the mortgage servicing process, and in particular, specifically to the process involving loan payoffs providing automation, expedited funds collection, and the generation of fee income. The process specifically provides a method and system that enables mortgage loan payoffs by means of electronic interaction between the payor and lien holder regardless of physical location and provides a choice of financial payment instruments.

2. Background of the Invention

One of the functions involved in the mortgage servicing process is the handling and processing of a customers mortgage loan payoff. This process involves the lien holder quoting a mortgage payoff amount, manually receiving a payoff check, validating the check to payoff amount, processing the payoff check, and updating the customers account on the loan file. The existing process today requires the physical movement of checks to the lien holders processing site as well as manually intensive processing for posting and clearing the payment. Elimination of physical check movement and manual processing will expedite the payoff process and mitigate financial risk. Applicant believes that the present manual mortgage loan payoff process can be automated using web based technology providing a secure site that will enable the mortgage lien holder to confirm, validate and accept loan payoffs.

Applicant believes that the use of current electronic payment technology utilized by financial institutions will enhance payment options and accelerate the movement of funds. Payment options would be expanded from conventional paper check to include Automated Clearing House (ACH) and Remote Deposit Capture (RDC). It is, therefore, an advancement to provide a new system and methodology centered on electronic information that does not require the use of physical paper for payment in the payoff process.

Applicant believes that significant transaction fee income can be generated for each transaction processed involving a mortgage loan paid off.

Reference:

2002 ACH Rules, A Complete Guide to Rules and Regulations Governing the ACG Network, National Automated Clearing House Association, Copyright 2002

U.S. Pat. No. 7,440,924—October, 2008 Buchanan, et al.—Method and system for processing financial instrument deposits physically remote from a financial institution

### BRIEF SUMMARY OF THE INVENTION

The object of this process improvement invention is to expedite the mortgage loan payoff process by utilizing current electronic payment technology therefore eliminating manual paper handling and processing, and the use of physical mail delivery while at the same time reducing financial risk and expediting funds collection.

This process improvement invention provides for the collection and settlement of mortgage loan payoff payments in either a single entity environment or consolidator environment. The invention allows for the current process of quoting the mortgage loan payoff by the lien holder, and provides a new process using a secure web site at which the payoff payment can be made and other documents submitted. This invention provides the individual, business, or third party a payment choice not offered in today's environment and delivers immediate confirmation that the payoff has been made and accepted. Additionally this invention provides for the elimination of manual payment processing, payment decisioning and automates the loan posting process.

### BRIEF DESCRIPTION OF DRAWINGS

FIG. 1 illustrates an overview of the process workflow from the request for payoff amount through payment origination, processing, clearing, and updating of the loan on the mortgage loan system.

### DETAILED DESCRIPTION OF THE INVENTION

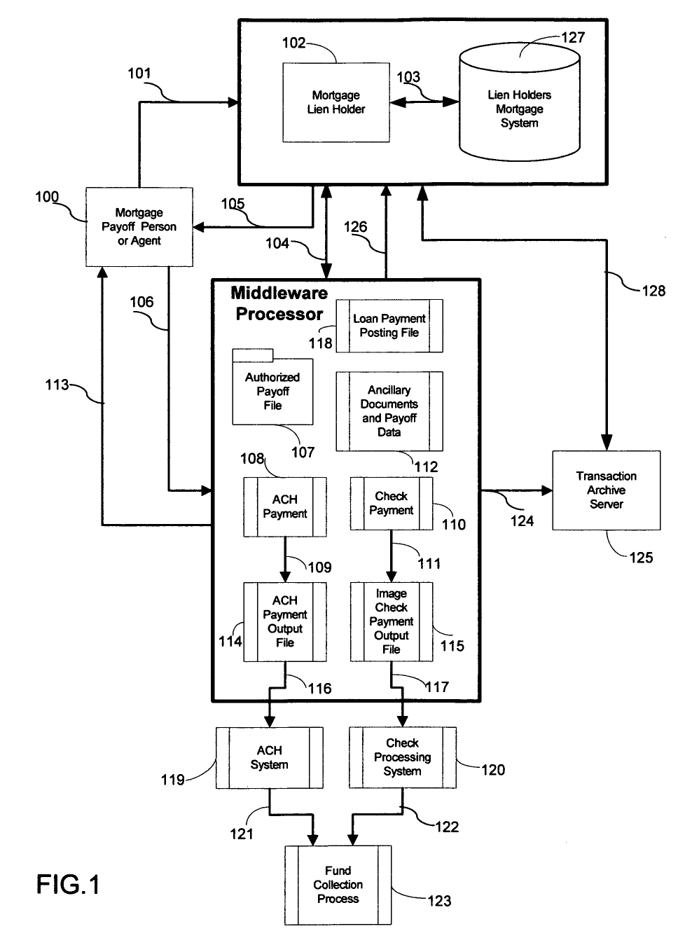

The workflow invention is described below with reference to the overview drawing as shown in FIG. 1. In describing the invention, the presented drawing should not be construed as to imposing any limitations on the invention. This invention provides both methods and processes for remotely accepting a mortgage loan payoff using either ACH or RDC and electronically processing the payment, and any associated document(s), without physically routing a paper copy of the check and or associated document as is done in today's environment. This invention utilizes either a special purpose computer, general purpose computer or server (or any combination there of) with client developed specific middleware designed to, but not limited to, receive, validate, process, create payment(s) and generate posting and archive files. This computer or server may also be referred herein as the “central system or middleware processor”.

Requests for a loan payoff (100) by Individual(s), business or other types of organizations will be communicated (101) to the lien holder (102) or servicer in the same manner and process as they exist today.

Upon receipt of the request the lien holder or servicer (102) will request (103) and obtain (103) the payoff amount from the Lien Holders Mortgage System (127). Prior to providing the information to the individual or business requesting the information, the payoff information will be sent or entered into the middleware server (104). A payoff record will then be created in an Authorized Payoff File on the middleware server (107). Payoff record should contain at a minimum but not be limited to the loan #, mortgagee name and address, payoff amount and transaction fee if applicable, payoff good through date, and any extraneous documents required for completing the payoff.

Upon set up completion of the payoff record on the Authorized Payoff File (107) a security password will be generated and sent back (104) to the lien holder or servicer (102). Once the security password is received, the payoff request information will be sent back (105) to the requestor (100) in the same manner and process as they exist today. Payoff location and payment methods however will be limited to the following options:

Payoff Location will no longer be a physical street address or PO Box for the payment to be sent to by US mail or overnight delivery (i.e FedEx, UPS, etc.), but a secure website requiring the security password generated by the Central System and provided with the payoff information requested. Options for payoff will consist of the following choices for the individual or business making the payoff, 1—origination of an ACH debit entry (108), 2—check payment, where the physical check will be scanned and input at the individual(s) or business remote location (110) using a TWAIN compliant scanner.

To payoff the loan (106), the individual or business (100) who requested the payoff information will sign on to the secure website and enter the security password that was provided with the payoff information. If security password is validated, information is displayed to complete the payoff (106), this should include but not be limited to the following: 1—Customer loan information (i.e, Loan #, Mortgagee name and address, payoff amount), 2—Transaction Fee Amount, 3—Additional documents or information required, 4—Payment method to be used (ACH(108) or Check(110)). Once customer information and payoff amount is validated by the individual or business making the payoff, the payment method to be used is selected and the financial transaction can proceed.

If ACH debit method is selected (108), financial information is input to generate a one time debit authorized transaction. Information input should conform to the requirements to generate an ACH debit transaction. Note: transaction fee amount can either be included in the payoff amount or be input as a separate ACH debit transaction. Once transaction information is input, validation will take place to insure that the bank routing information is correct and that the transaction amount is in agreement with the payoff amount. If additional information (112) is required to complete the payoff it will be either key entered or input to the customer payoff transaction file using a TWAIN compliant scanner. Once payment transaction is completed and validated, a payment confirmation record will be sent back (113) to the individual or business (100) making the payment for their records.

If check payment method is selected (110), system will prompt the individual or business using RDC to place the physical check on any TWAIN compliant scanner. The check will be scanned, image quality validated, MICR and amount information validated, and amount validated to insure that the transaction is in agreement with the payoff amount. Once validation is completed a payment transaction is generated. Transaction will consist of both check image and Meta data required for electronic clearing of the item. Note: transaction fee amount can either be included in the payoff amount or be input as a separate check payment transaction. If additional information (112) is required to complete the payoff it will be either key entered or input to the customer payoff transaction file using a TWAIN compliant scanner. Once payment transaction is completed and validated, a payment confirmation record will be sent back (113) to the business or individual (100) making the payment for their records.

At the end of day cutoff, or at such time when payments received are scheduled to be consolidated and released for collection, transaction information of both the ACH payments (108) and the check payments (110) are then sent (109,111) to the appropriate application and an output file is generated for both ACH payments (114) and check payments (115) in the appropriate format. Upon completion of the ACH and Image Check output file generation, the files are sent (116,117) to the primary ACH System (119) or Check Processing System (120). Both the ACH System (119) and the Check Processing System (120) will then generate and input (121,122) the appropriate files into the Funds Collection Processing Streams (123) for payment.

At end of day, or in online real-time mode, once a payoff transaction has been accepted, completed, and a confirmation message provided, a file or record of the completed transaction is generated by the Loan Payment Posting File (118) in the Middleware Server and is sent (126) to the Mortgage Lien Holder (102) for input submission (103) to the Lien Holders Mortgage System (127). A variation to updating the Lien Holders Mortgage System (127) would be to directly input the loan payment updates into the Lien Holders Mortgage System (127) without human intervention for approval prior to submission.

As a safeguard all payment transaction information and history should be transferred (124) either at end of day or real time to a separate Transaction Archive Server (125) that can be used for data/image storage as well as for inquiry for research accessible by the Mortgage Lien Holder (102). Inquiry and access should take place via internet (128) with the appropriate security measures.

Although the present invention has been described in relation to particular embodiments thereof, many other variations, modifications and other uses will become apparent to those skilled in the art. It is preferred, therefore, that the present invention be limited not by the specific disclosure herein, but only by the appended claims.

I claim:

1. A process and method for paying off a real estate loan(s) at a central location by means of the internet and a secure web site, utilizing existing technology applications consisting of, but not limited to, both ACH or presenting a check image (RDC) from a remote site with accompanying payoff information if required, that accelerates the loan payoff process, provides automation of the loan payoff process, and mitigates financial risk that is comprised of:
a central system for receiving payoff payments and information from a multitude of mortgagees and or their representatives where payments and ancillary information received for each loan payoff transaction may vary depending on the requirements set forth by the mortgage lien holder;
mortgage lien holder is responsible for specific payoff amount and ancillary information required on the central sites system (Information will include, but is not limited to the following, mortgagee loan number, mortgagee name and address, the required payoff amount, transaction fee, and ancillary information required for loan payoff);
individuals, businesses, or representative third parties requesting mortgage payoff information will be provided a secure website and security pass code allowing access to the web site and only a specific mortgagee's account;
payment method selection of ACH or check image (RDC) will be initiated by the party accessing the website with the appropriate security pass code and provides for receiving customer originated information allowing for the origination of an ACH debit transaction as well as receiving endorsed and or unendorsed check image and check data from the remote site for processing;
payment input for payoff must match the amount displayed for the mortgagee as it appears on the Authorized Payoff File including transaction fees;
transaction fees can be either included in the loan payoff amount or paid as a separate transaction;
ancillary data must be provided as required;
central system will verify and validate all information prior to completion of the transaction or the transaction is rejected;
confirmation message is immediately provided to the originator of the payment once the transaction is accepted;
payoff and ancillary information received for each loan payment accepted is split out for input and processing to the appropriate lien holder's Mortgage Loan System;
central system will store and copy to a back up processor or data base all payment data (ACH and check) along with any ancillary information or images received in the payoff process.

2. The process and method as defined in claim 1, provides for the charging and collection of payoff transaction fees through the elimination of overnight mail delivery costs, by providing immediate payoff acceptance confirmation of the loan payment received, and eliminates the need for the lien holder to make adjustments for either under or over payment resulting from an incorrect loan payoff payment being received.

3. The process and method as defined in claim 1, can be utilized for processing any type of loan payoff transaction where the lien holder provides the individual, business or third party paying the loan, a payoff quote and requires a physical check to be mailed to them for processing, posting and collection.
